(19) United States
(12) Patent Application Publication
(10) Pub. No.: US 2007/0238837 A1
(43) Pub. Date: Oct. 11, 2007

(54) Compounds containing allophanate, isocyanate and ortho ester groups and their use as binders

(75) Inventors: Dieter Mager, Leverkusen (DE); Holger Mundstock, Wermelskirchen (DE); Meike Niesten, Koln (DE); Jorg Schmitz, Koln (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/401,427

(22) Filed: Apr. 10, 2006

(30) Foreign Application Priority Data
Apr. 13, 2005 (DE) 102005016982.1

(51) Int. Cl. C08F 283/04

(52) U.S. Cl. 525/454

(57) ABSTRACT

The present invention relates to a process for preparing compounds which contain allophanate groups, free NCO groups and polyortho ester groups by reacting A) one or more aliphatic and/or cycloaliphatic polyisocyanates with B) one or more polyortho esters containing at least one hydroxyl group per molecule to form NCO-functional polyurethanes and then reacting some or all of the urethane groups to form allophanate groups. The present invention relates to compounds obtained by this process and to their use as binders in coating, sealant and adhesive compositions that also contain catalysts and optionally additives.

### BACKGROUND OF THE INVENTION

1. Field of the Invention

The present invention relates to new compounds containing allophanate groups, NCO groups and polyortho ester groups, to a process for preparing them and to their use as binders in coating, sealant and adhesive compositions.

2. Description of Related Art

The use of polyortho esters and bicyclic ortho esters (BOE) as blocked polyols in polyurethane coating compositions is known (EP-A 0 882 106 and EP-A 1225 172; German patent application DE 10 200 400 34 95, unpublished at the priority date of the present specification).

Under the influence of atmospheric moisture the polyortho ester and BOE groups undergo deblocking (hydrolysis), releasing hydroxyl groups, which are then available for crosslinking with polyisocyanates.

EP-A 0 882 106 includes in its description the use of bicyclic ortho esters as reactive diluents, free from elimination products, in polyurethane coating systems.

WO 99/10397 A1 and DE 10 200 400 34 95 disclose compounds which in addition to bicyclic ortho ester groups or polyortho ester groups, respectively, also contain free NCO groups, so that, after the latent OH groups have undergone deblocking, the NCO groups can be cured by self-crosslinking.

The self-crosslinking systems of DE 10 200 400 34 95, which are based on polyortho ester groups, have the advantage over the rapid-crosslinking systems from WO 99/10397, which are based on bicyclic ortho ester groups, that the preparation process is substantially simpler from a technical standpoint and therefore of greater commercial interest.

For automotive refinish applications, the demand is for coating compositions which dry quickly and feature high-hardness and good chemical resistance. These compositions are preferably based on linear aliphatic isocyanates. In order to increase productivity, a primary demand is for even more rapid drying than it has been possible to achieve to date using 2 K (two-component) PU coating compositions. Also, for reasons of reliability of application, maximum pot lives are required.

It has now been found that allophanates prepared from aliphatic isocyanates and hydroxy-functional polyortho esters lead to self-crosslinking adducts having masked OH groups and free NCO groups that can be employed as binders in fast-drying polyurethane coating systems featuring high mechanical resistance and high chemical resistance.

### SUMMARY OF THE INVENTION

The present invention relates to a process for preparing compounds which contain allophanate groups, free NCO groups and polyortho ester groups by reacting
A) one or more aliphatic and/or cycloaliphatic polyisocyanates with
B) one or more polyortho esters containing at least one hydroxyl group per molecule
   to form NCO-functional polyurethanes and then reacting some or all of the urethane groups to form allophanate groups.

The present invention relates to the compounds obtained by this process and to their use as binders in coating, sealant and adhesive compositions that also contain catalysts and optionally additives.

### DETAILED DESCRIPTIOON OF THE INVENTION

Examples of suitable aliphatic or cycloaliphatic polyisocyanates (A) include linear di- or triisocyanates such as butane diisocyanate, pentane diisocyanate, hexane diisocyanate (hexamethylene diisocyanate, HDI) and 4-isocyanatomethyl-1,8-octane diisocyanate (triisocyanatononane, TIN); or cyclic di- or triisocyanates such as 4,4′-methylenebis(cyclohexyl isocyanate), 3,5,5-trimethyl-1-isocyanato-3-isocyanatomethylcyclohexane (isophorone diisocyanate, IPDI) and ω,ω′-diisocyanto-1,3-dimethylcyclohexane (H₆XDI).

Preferred polyisocyanates A include hexane diisocyanate (hexamethylene diisocyanate, HDI), 4,4′-methylenebis(cyclohexyl isocyanate) and/or 3,5,5-trimethyl-1-isocyanato-3-isocyanatomethylcyclohexane (isophorone diisocyanate, IPDI). An especially preferred polyisocyanate is HDI.

Suitable hydroxy-functional polyortho esters B) are obtained by reacting
B1) one or more acyclic ortho esters with
B2) one or more polyols having a functionality of 4 to 8 and a number average molecular weight of 80 to 500 g/mol and
B3) optionally a 1,3-diol, in which the hydroxyl groups are separated from one another by at least 3 carbon atoms, and/or a triol,
   optionally in the presence of
B4) catalysts.

The resulting oligomer mixtures of ortho esters which contain not only bicyclic structures (like the pure ortho esters), but also open-chain structures. The advantages of this oligomer mixture are its performance properties, which are better, and its ease of preparation, which is significantly better from a technical standpoint. The preparation is also simpler than the preparation of the pure bicyclic ortho esters, as ideal transesterification products of 1 mole of acyclic ortho ester and 1 mole of an at least tetrafunctional alcohol.

Examples of component B1) include triethyl orthoformate, triisopropyl orthoformate, tripropyl orthoformate, trimethyl orthobutyrate, triethyl orthoacetate, trimethyl orthoacetate, triethyl orthopropionate and trimethyl orthovalerate. Preferred are triethyl orthoformate, triethyl orthoacetate, trimethyl orthoacetate and/or triethyl orthopropionate, especially triethyl orthoacetate and triethyl orthopropionate. These compounds can be used in component B1) individually or in any desired mixtures with one another.

Examples of component B2) include pentaerythritol, ditrimethylolpropane, erythritol, diglyceride, bis(trimethylolpropane), dipentaerythritol, mannitol or methylglycoside. It is preferred to use pentaerythritol in B2).

Examples of 1,3-diols for component B3) include neopentyl glycol, 2-methyl-1,3-propanediol, 2-methyl-2,4-pentanediol, 3-methyl-1,3-butanediol, 2-ethyl-1,3-hexanediol, 2,2-diethyl-1,3-propanediol, 2,2,4-trimethyl-1,3-pentanediol, 2-butyl-2-ethyl-1,3-propanediol, 2-phenoxypropane-1,3-diol, 2-methyl-2-phenylpropane-1,3-diol, 1,3-propylene glycol, 1,3-butylene glycol, dimethylolpropionic acid, dimethylolbutanoic acid, 2-ethyl-1,3-octanediol and 1,3-dihydroxycyclohexane. Also suitable are fatty acid monoglycerides (β products) such as glyceryl monoacetate (β product) and glyceryl monostearate (β product). Preferred are neopentyl glycol, 2-methyl-1,3-propanediol, 2-methyl-2,4-pentanediol, 3-methyl-1,3-butanediol, 2-ethyl-1,3-hexanediol, 2,2-diethyl-1,3-propanediol, 2,2,4-trimethyl-1,3-pentanediol and 2-butyl-2-ethyl-1,3-propanediol.

Examples of triols for component B3) include 1,2,3-propanetriol, 1,2,4-butanetriol, 1,1,1-trimethylolethane, 1,2,6-hexanetriol, 1,1,1-trimethylolpropane and polyester-based triols having a number average molecular weight of from 100 to 1000 g/mol. The latter can be prepared, for example, from the preceding triols by reaction with lactones, such as ε-caprolactone, β-propiolactone, γ-butyrolactone, γ- and δ-valerolactone, 3,5,5- and 3,3,5-trimethylcaprolactone and mixtures thereof. A preferred triol for component B3) is trimethylolpropane.

The equivalent ratio of groups of the compounds of component B1) to be transesterified to the OH groups of the compounds of components B2) and B3) is from 1:1.3 to 1:1.5.

As catalysts for the transesterification reaction to prepare component B) it is possible to use the known esterification catalysts, such as acids, bases or transition metal compounds. Preferred are Lewis or Broenstedt acids; p-toluenesulphonic acid is particularly preferred. The catalysts are used in the process of the invention in amounts of from 0.001 to 5% by weight, preferably from 0.01 to 1% by weight, based on the total weight components B1)-B3).

The reaction temperature of the transesterification reaction is from 50 to 200° C., preferably from 75 to 150° C. In one preferred embodiment of the invention the alcohol eliminated in the course of the transesterification is removed from the reaction mixture by distillation, employing reduced pressure if appropriate. In this way it is easy to recognize not only the shift in equilibrium but also the end of the transesterification reaction. The said reaction is complete when elimination product (alcohol) is no longer distilled over.

The urethanization reaction of A) with B) can be carried out using known catalysts from polyurethane chemistry. Examples are tin soaps, such as dibutyltin dilaurate, or tertiary amines, such as triethylamine or diazobicyclooctane.

The NCO/OH equivalent ratio of component A) to component B) is typically>1, preferably 1:4 to 1:20, more preferably 1:4 to 1:15, and most preferably 1:4 to 1:10.

The temperature during the urethanization reaction is preferably 20 to 140° C., more preferably 40 to 100° C.

The allophanatization reaction takes place subsequently by reaction of the polyurethane containing isocyanate groups, in the presence of, preferably, tin or zinc(II) compounds or quaternary ammonium compounds as allophanatization catalysts. Some or all of the urethane groups present undergo allophanatization by reaction with free NCO groups. It is possible, in addition to the isocyanates already present in A), to add other isocyanates, which may be different from A). The temperature during the allophanatization reaction is preferably 20 to 140° C., more preferably 40 to 100° C.

After the end of the allophanatization reaction it is possible to remove excess, unreacted di- or polyisocyanate from the product by means of thin-film distillation or extraction, for example. Thin-film distillation is the preferred separation method and is generally carried out at temperatures from 100 to 160° C. under a pressure of 0.01 to 3 mbar. The residual monomer content thereafter is preferably less than 1% by weight, more preferably less than 0.5% by weight (diisocyanate).

For the allophanatization it is preferred to use tin or zinc(II) compounds as catalysts, preferably zinc soaps of relatively long-chain, branched or unbranched, aliphatic carboxylic acids. Particularly preferred zinc(II) soaps are those based on 2-ethylhexanoic acid or on the linear, aliphatic C₄ to C₃₀ carboxylic acids. Especially preferred zinc(II) soaps are Zn(II) bis(2-ethylhexanoate), Zn(II) bis(n-octoate), Zn(II) bis(stearate) or mixtures thereof.

Other preferred allophanatization catalysts are quaternary ammonium salts, preferably quaternary ammonium hydroxides of the formula 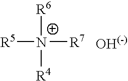
wherein
R⁴ is an alkyl radical having 1 to 12, preferably 4 to 12, carbon atoms, an araliphatic hydrocarbon radical having 7 to 10, preferably 7, carbon atoms or a saturated cycloaliphatic hydrocarbon radical having 4 to 10, preferably 5 to 6, carbon atoms, each of which may be substituted by hydroxyl and/or hydroxyalkyl groups having 1 to 4 carbon atoms; and
R⁵, R⁶ and R⁷ are identical or different radicals and are optionally hydroxyl-substituted alkyl radicals having 1 to 20, preferably 1 to 4, carbon atoms, or two of the radicals R⁵, R⁶ or R⁷ form, together with the nitrogen atom, optionally together with an oxygen atom or with a further nitrogen atom, a heterocyclic ring having 3 to 5 carbon atoms, or the radicals R⁵, R⁶ and R⁷ are each ethylene radicals, which together with the quaternary nitrogen atom and a further tertiary nitrogen atom form a bicyclic triethylene diamine (DABCO) structure.

Preferred quaternary ammonium hydroxides are those of the preceding formula in which the radicals R⁵, R⁶ and R⁷ are as defined, provided that at least one of the radicals has at least one aliphatically bound hydroxyl group arranged preferably in the 2 position relative to the quaternary nitrogen atom. It is also possible for the hydroxyl-substituted radical or radicals to contain, as well as the hydroxyl substituent(s), any desired other inert substituents, particularly C₁-C₄ alkoxy substituents.

Particularly preferred quaternary ammonium hydroxides are those of the preceding formula in which the radicals R⁴, R⁵ and R⁶ are each alkyl radicals and R⁷ is a hydroxyethyl, hydroxypropyl or hydroxybutyl radical in which the hydroxyl group is arranged preferably in the 2 position relative to the quaternary nitrogen atom.

Examples of suitable quaternary ammonium hydroxides include benzyltrimethyl-ammonium hydroxide; tetramethyl-, tetraethyl-, trimethylstearyl-, or dimethylethyl-cyclohexyl-ammonium hydroxide; N,N,N-trimethyl-N-(2-hydroxy-ethyl)-,N,N,N-trimethyl-N-(2-hydroxypropyl)-, or N,N,N-trimethyl-(2-hydroxybutyl)-ammonium hydroxide; N,N-dimethyl-N-dodecyl-N-(2-hydroxyethyl)ammonium hydroxide; N-(2-hydroxyethyl)-N,N-dimethyl-N-(2,2′-dihydroxymethylbutyl)ammonium hydroxide; N-methyl-2-hydroxyethylmopholinium hydroxide; N-methyl-N-(2-hydroxypropyl)pyrrolidinium hydroxide; N-dodecyl-tris-N-(2-hydroxyethyl)ammonium hydroxide; tetra(2-hydroxyethyl)ammonium hydroxide; and the compounds of the formula 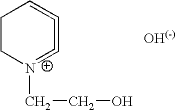
which represents the monoadduct of ethylene oxide and water with DABCO.

Besides the preferred hydroxyalkylammonium hydroxides specified above, benzyltrimethylammonium hydroxide (Triton B) is also a preferred quaternary ammonium hydroxide.

The allophanatization catalysts are preferably used in an amount of 0.0001 to 2%, more preferably 0.001 to 1% by weight, based on the diisocyanate mixture employed.

Particularly when using quaternary ammonium hydroxides as catalysts, they are used in the form of a solution in appropriate solvents. Appropriate solvents include toluene, dimethylformamide, dimethyl sulphoxide or mixtures thereof. The solvents are used in amounts of not more than 5% by weight, based on isocyanate mixture employed. Following the reaction the solvents, optionally together with any excess diisocyanates, are removed by distillation.

After the allophanatization reaction it is also possible to use stabilizing additives. Examples include acidic additives such as Lewis acids (electron-deficient compounds) or Broenstedt acids (protic acids) or compounds which release these acids on reaction with water. Examples of the latter include organic or inorganic acids or neutral compounds, such as acid halides or esters, which react with water to form the corresponding acids. Examples of acids include hydrochloric acid, phosphoric acid, phosphoric esters, benzoyl chloride, isophthaloyl dichloride, p-toluenesulphonic acid, formic acid, acetic acid, dichloroacetic acid and 2-chloropropionic acid.

The acidic additives are used to deactivate the allophanatization catalyst. In addition they enhance the stability of the allophanates prepared in accordance with the invention, for example, to thermal exposure during thin-film distillation and after preparation during storage of the products.

The acidic additives are generally added at least in an amount such that the molar ratio of the acidic centers of the acidic additive to the catalyst is at least 1:1. Preferably, an excess of the acidic additive is added.

Where acidic additives are used, they are preferably organic acids such as carboxylic acids or acid halides such as benzoyl chloride or isophthalyl dichloride.

The process steps can optionally be carried out in the presence of inert solvents. Inert solvents are those which do not react with the reactants under the reaction conditions. Examples include ethyl acetate, butyl acetate, methoxypropyl acetate, methyl ethyl ketone, methyl isobutyl ketone, toluene, xylene, aromatic or (cyclo)aliphatic hydrocarbon mixtures and mixtures thereof. Preferably, the reactions are carried out solvent-free.

Binders containing the compounds according to the invention represent diverse starting materials for the preparation of low-viscosity, low-solvent polyurethane systems which are free from elimination products and can be formulated as self-crosslinking systems.

The coating compositions according to the invention contain as binders
a) one or more compounds containing allophanate groups, polyortho ester groups and NCO groups,
b) catalysts and
c) optionally additives.

Catalysts b) include individual catalysts and also mixtures of two or more catalysts which catalyze different reactions. To catalyze the deblocking reaction to release the masked OH groups use is made of acid compounds. Examples include inorganic acids such as hydrogen chloride, sulphuric acid and nitric acid; sulphonic acids such as methanesulphonic acid, ethanesulphonic acid, para-toluenesulphonic acid, dodecylbenzenesulphonic acid, dinonylnaphthalene- sulphonic acid and dinonylnaphthalenedisulphonic acid; carboxylic acids such as formic acid, acetic acid, propionic acid, butanoic acid, 2-ethylhexanoic acid and octanoic acid; organic compounds based on phosphoric acid, such as monobutyl phosphate, dibutyl phosphate, monoisopropyl phosphates, diisopropyl phosphates, monooctyl phosphates, dioctyl phosphates, monodecyl phosphates, didecyl phosphates, metaphosphoric acid, orthophosphoric acid, pyrophosphoric acid, trimethyl phosphates, triethyl phosphate, tributyl phosphates, trioctyl phosphate, tributoxyethyl phosphates, trischloroethyl phosphate, triphenyl phosphate and tricresyl phosphate; and Lewis acids.

It is also possible to use neutralization products of the preceding acids with amines as catalysts b). Additionally, it is possible to use sulphonic esters of the aforementioned sulphonic acids with primary, secondary or tertiary alcohols such as n-propanol, n-butanol, n-hexanol, n-octanol, isopropanol, 2-butanol, 2-hexanol, 2-octanol, cyclohexanol, and tert-butanol; and also reaction products of the sulphonic acids with compounds containing oxirane groups, such as glycidyl acetate or butyl glycidyl ether, to obtain β-hydroxyalkylsulphonic esters.

Preferred acid catalysts for use as component b) are the compounds based on sulphonic acid and based on phosphoric acid. Especially preferred is dodecylbenzenesulphonic acid.

Besides the acid catalysts, component b) may also contain catalysts for accelerating the NCO/OH reaction of the released latent OH groups with NCO groups. These catalysts are known from polyurethane chemistry and include tertiary amines such as triethylamine, pyridine, methylpyridine, benzyl-dimethylamine, N,N-endoethylenepiperazine, N-methylpiperidine, pentamethyldiethylenetriamine, N,N-dimethylaminocyclohexane, and N,N′-dimethylpiperazine; metal salts such as iron(III) chloride, zinc chloride, zinc 2-ethylcaproate, tin(II) octoate, tin(II) ethylcaproate, tin(II) palmitate, dibutyltin(IV) dilaurate and molybdenum glycolate; and mixtures of these catalysts.

For component b) it is preferred to use a combination of acid catalysts and NCO/OH-accelerating catalysts. The amount of component b), based on the amount components a) and b) is preferably from 0.001 to 5% by weight, more preferably from 0.01 to 1% by weight.

Suitable additives c) include surface-active substances, internal release agents, fillers, dyes, pigments, flame retardants, hydrolysis stabilizers, microbicides, flow aids, antioxidants such as 2,6-di-tert-butyl-4-methylphenol, UV-absorbers of the 2-hydroxyphenylbenzotriazole type, light stabilizers of the HALS type that may be unsubstituted or substituted on the nitrogen atom (such as Tinuvin® 292 and Tinuvin® 770 DF, Ciba Spezialitäten GmbH, Lampertheim, DE) or other known stabilizers, such as those described in “Lichtschutzmittel für Lacke” (A. Valet, Vincentz Verlag, Hannover, 1996 and “Stabilization of Polymeric Materials” (H. Zweifel, Springer Verlag, Berlin, 1997, Appendix 3, pp. 181-213). Mixtures of these compounds may also be used.

To prepare the coating compositions of the invention, components a), b) and optionally c) are mixed with one another.

The binders of the coating compositions that contain the compounds of the invention containing polyortho ester, NCO and allophanate groups are suitable for coating various materials and substrates, such as metal, wood, glass, stone, ceramic materials, concrete, rigid and flexible plastics, textiles, leather or paper. The coating composition can be applied to the substrates by known methods, such as spraying, brushing, flow coating or using rollers or coating knives. Curing can be performed at room temperature or at elevated temperature.

### EXAMPLES

All amounts are to be understood as being by weight in grams unless noted otherwise. All percentages, unless noted to the contrary, are understood as being percent by weight.

The NCO content of the resins described in the inventive and comparative examples was determined by titration in accordance with DIN 53 185.

Reaction 1 shows that for each polyortho ester group one OH group was released by hydrolysis:

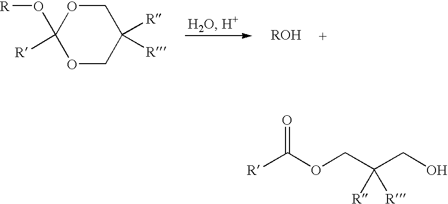

Reaction 1: Hydrolysis (deblocking) of polyortho esters.

The latent OH group content was calculated theoretically using the following equation:

$$OH content = \frac{2 \cdot 17 \cdot 100}{mass of product starting from 1 mol of TEOA}$$

To monitor the NCO conversion, samples of the reaction solution were measured using an FT-IR spectrometer (Perkin Elmer, Paragon 1000, GB) and the presence of free NCO groups was detected on the basis of the NCO band at 2270 cm¹.

The dynamic viscosities were determined at 23° C. using a rotational viscometer (ViscoTester® 550, Thermo Haake GmbH, D-76227 Karlsruhe).

The König pendulum hardness was determined in accordance with DIN 53157. Solids content was determined in accordance with DIN EN ISO 3251 (1 g of sample, drying time in a forced-air oven: 1 hour at 125° C.).

As a measure of the pot life the efflux time was determined in accordance with DIN 53211.

The drying rate was determined in accordance with DIN 53150 and DIN EN ISO 1517.

### Reactants

TEOA: triethyl orthoacetate

BEPD: 2-butyl-2-ethyl-1,3-propanediol

pTSA: para-toluenesulphonic acid

MPA: methoxypropyl acetate

DBTL: dibutyltin dilaurate

HDI: hexamethylene diisocyanate

Byk® 333, 355, 331 and 141: flow aids from Byk Chemie, Wesel, DE

Polyisocyanate A: Desmodur® VPLS 2102, an HDI allophanate having an NCO content of 20.0% and a viscosity at 23° C. of 300 mPa.s, Bayer AG, Leverkusen, DE.

### EXAMPLE 1

### Adduct (1)

Part 1 of the reactants for preparing the adduct were weighed out together in accordance with Table 1 below into a reactor equipped with stirrer, heating, automatic temperature control, nitrogen inlet and distillation column, and were heated to 85° C. with stirring while nitrogen was passed through the mixture. The temperature was slowly raised to 120° C., with ethanol being removed by distillation. After 4 to 6 hours the distillation of ethanol was at an end and a reduced pressure of 500 mbar was applied at 120° C. in order to distill off the remaining ethanol.

Thereafter the product was added dropwise over the course of 1 hour at 100° C. to part 3, 0.16 gram of dibutyltin laurate and 0.6 gram of ionol. The reaction mixture was subsequently stirred for 3 hours until a theoretical NCO content of 36.1% by weight was reached. Then 0.16 gram of a 10% strength by weight solution of zinc octoate in ethanol was added in 2 portions 5 minutes apart, and reaction was continued at 105 to 110° C/ to an NCO content of 32.1% by weight. Then 0.1 g of benzoyl chloride was added. The excess HDI was removed by thin-film distillation. The product was dissolved in butyl acetate (80% strength). The NCO content was 10.1%, the latent OH content was 5%, and the viscosity at 23° C. was 565 mPa.s.

### EXAMPLE 2

### Adduct 2 (Comparative)

Part 1 of the reactants for preparing the adduct were weighed out together in accordance with Table 1 below into a reactor equipped with stirrer, heating, automatic temperature control, nitrogen inlet and distillation column, and were heated to 85° C. with stirring while nitrogen was passed through the mixture. The temperature was slowly raised to 120° C., with ethanol being removed by distillation. After 4 to 6 hours the distillation of ethanol was at an end and a reduced pressure of 500 mbar was applied at 120° C. in order to distill off the remaining ethanol. Subsequently butyl acetate (part 2) was added. At 120° C. the polyisocyanate (part 3) was added dropwise and the reaction was continued at 120° C. until the theoretical NCO content was reached

TABLE 1
Polyortho ester allophanate

| Adduct | 1 | 2 |
|---|---|---|
| Part 1: | | |
| TEOA | 122 g | 162 g |
| Pentaerythritol | 77 g | 136 g |
| BEPD | 60 | — |
| pTSA | — | — |
| Ethanol | −104 g | −138 g |
| Part 2 | | |
| Butyl acetate | | 198 g |
| Part 3 | | |
| HDI | 630 | |
| Polyisocyanate A | | 630 g |
| Solids | 80% | 80% |
| NCO content | 10.1% | 8.3% |
| Latent OH content | 5.0% | 3.4% |
| Viscosity @ 23° C. | 565 mPas | 380 mPas |

Coating Preparation

Adducts 1) and 2) were admixed according to the table below with known coating additives, catalysts and optionally polyisocyanates, and then were applied to glass using a 150 μm coating knife and cured at 60° C. for 10 minutes. (Example 3 and comparative Example 4)

The chemical resistance of the resulting coating films was determined by placing a cotton pad soaked with solvent on the coating film for 1 minute and 5 minutes, respectively. After this time the paint film was wiped dry with a cloth and assessed visually using a grading of 0-5. (0: no change, 5: severe swelling).

TABLE 2
Coating & performance data

| Example | 3 | 4 |
|---|---|---|
| Adduct 1 | 100 | |
| Adduct 2 (comparative) | | 100 |
| Byk ® 331 | 0.16 | 0.16 |
| Byk ® 141 | 1.00 | 1.00 |
| DBTL | 1.60 | 1.60 |
| MPA/xylene/BA 1:1:1 | 32.11 | 34.99 |
| Dodecylbenezenesulphonic acid | 5.00 | 5.00 |
| Solids | 58 | 57 |
| Efflux time DIN4 (sec) after | | |
| 0.0 h | 18 | 21 |
| 1.0 | 16 | 19 |
| 2.0 | 17 | 19 |
| 3.0 | 18 | 20 |
| 4.0 | 18 | 20 |
| Drying time RT | | |
| T1 + min | 35 | 40 |
| T3 + h | 50 | 85 |
| T4 + h | 1.4 | 2.5 |
| Pendulum hardness | | |
| 7 d RT | 55 | 17 |
| 30 min 60° C. | 87 | 16 |
| 7 d RT 16 H 70° C. | 127 | 76 |
| Solvent resistance | | |
| (MPA/X/BA/MEK) | 0013 | 1113 |

0 = no change, 5 = severe swelling

As is very clear from the efflux times, as a measure of the processing properties, and the drying times after application, the inventive coating systems (Example 3) are distinguished by high application reliability and fast drying behavior. In addition, the hardness and chemical resistance are better than those of comparative Example 4.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

what is claimed is:

1. A process for preparing a compound containing allophanate groups, free NCO groups and polyortho ester groups which comprises reacting
A) one or more aliphatic and/or cycloaliphatic polyisocyanates with
B) one or more polyortho esters containing at least one hydroxyl group per molecule,
to form an NCO-functional polyurethane and then reacting some or all of the urethane groups present to form allophanate groups.

2. The process of claim 1 wherein polyisocyanates A) comprise hexamethylene diisocyanate, 4,4′-methylenebis(cyclohexyl isocyanate) or 3,5,5-trimethyl-1-isocyanato-3-isocyanatomethylcyclohexane.

3. The process of claim 1 which comprises preparing polyortho esters B) by reacting
B1) one or more acyclic ortho esters with
B2) one or more polyols having a functionality of 4 to 8 and a number average molecular weight of 80 to 500 g/mol and
B3) optionally a 1,3-diol, in which the hydroxyl groups are separated from one another by at least 3 carbon atoms, and/or a triol,
optionally in the presence of
B4) a catalyst.

4. The process of claim 3 wherein component B1) comprises triethyl orthoacetate or triethyl orthopropionate, component B2) comprises pentaerythritol and component B3) comprises neopentyl glycol, 2-methyl-1,3-propanediol, 2-methyl-2,4-pentanediol, 3-methyl-1,3-butanediol, 2-ethyl-1,3-hexanediol, 2,2-diethyl-1,3-propanediol, 2,2,4-trimethyl-1,3-pentanediol, 2-butyl-2-ethyl-1,3-propanediol or trimethylolpropane.

5. The process of claim 1 wherein the NCO/OH equivalent ratio of component A) to component B) is 1:4 to 1:10.

6. The process of claim 1 wherein an allophanatization catalyst is present and comprises a tin compound, a zinc(II) compound or a quaternary ammonium compound.

7. The process of claim 1 wherein an allophanatization catalyst is present and comprises benzyltrimethylammonium hydroxide.

8. A compound containing allophanate groups, free NCO groups and polyortho ester groups that is prepared by a process which comprises reacting
A) one or more aliphatic and/or cycloaliphatic polyisocyanates with
B) one or more polyortho esters containing at least one hydroxyl group per molecule,
to form an NCO-functional polyurethane and then reacting some or all of the urethane groups present to form allophanate groups.

9. The compound of claim 8 wherein polyortho esters B) are the reaction product of
B1) one or more acyclic ortho esters with
B2) one or more polyols having a functionality of 4 to 8 and a number average molecular weight of 80 to 500 g/mol and
B3) optionally a 1,3-diol, in which the hydroxyl groups are separated from one another by at least 3 carbon atoms, and/or a triol.

10. The compound of claim 9 wherein component B1) comprises triethyl orthoacetate or triethyl orthopropionate, component B2) comprises pentaerythritol and component B3) comprises neopentyl glycol, 2-methyl-1,3-propanediol, 2-methyl-2,4-pentanediol, 3-methyl-1,3-butanediol, 2-ethyl-1,3-hexanediol, 2,2-diethyl-1,3-propanediol, 2,2,4-trimethyl-1,3-pentanediol, 2-butyl-2-ethyl-1,3-propanediol or trimethylolpropane.

11. The compound of claim 8 wherein polyisocyanates A) comprise hexamethylene diisocyanate, 4,4′-methylenebis(cyclohexyl isocyanate) or 3,5,5-trimethyl-1-isocyanato-3-isocyanatomethylcyclohexane.

12. The compound of claim 9 wherein polyisocyanates A) comprise hexamethylene diisocyanate, 4,4′-methylenebis(cyclohexyl isocyanate) or 3,5,5-trimethyl-1-isocyanato-3-isocyanatomethylcyclohexane.

13. The compound of claim 10 wherein polyisocyanates A) comprise hexamethylene diisocyanate, 4,4′-methylenebis(cyclohexyl isocyanate) or 3,5,5-trimethyl-1-isocyanato-3-isocyanatomethylcyclohexane.

14. The compound of claim 8 wherein the NCO/OH equivalent ratio of component A) to component B) is 1:4 to 1:10.

15. The compound of claim 9 wherein the NCO/OH equivalent ratio of component A) to component B) is 1:4 to 1:10.

16. The compound of claim 10 wherein the NCO/OH equivalent ratio of component A) to component B) is 1:4 to 1:10.

17. The compound of claim 11 wherein the NCO/OH equivalent ratio of component A) to component B) is 1:4 to 1:10.

18. The compound of claim 12 wherein the NCO/OH equivalent ratio of component A) to component B) is 1:4 to 1:10.

19. The compound of claim 13 wherein the NCO/OH equivalent ratio of component A) to component B) is 1:4 to 1:10.

20. A coating, adhesive or sealant composition wherein the binder comprises the compound containing allophanate groups, free NCO groups and polyortho ester groups of claim 8.
